(19) United States
(12) Patent Application Publication
(10) Pub. No.: US 2006/0072746 A1
(43) Pub. Date: Apr. 6, 2006

(54) Register scheduling in iterative block encryption to reduce memory operations

(76) Inventor: Hari K. Tadepalli, Chandler, AZ (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/953,864

(22) Filed: Sep. 28, 2004

(51) Int. Cl. H04K 1/06

(52) U.S. Cl. 380/37

(57) ABSTRACT

Systems and methods encrypt data according to a multi-round, block encryption algorithm, In some embodiments, each round includes transforming data held in a group of registers of a processor register set and maintaining round output in the group of registers to use as input in a subsequent round. In some embodiments, the multi-round, block encryption algorithm is the Advanced Encryption Standard algorithm.

### TECHNICAL FIELD

The inventive subject mater relates to block encryption algorithms and, more particularly, to register scheduling in iterative block encryption to reduce memory operations.

### BACKGROUND INFORMATION

Various block encryption algorithms exist today. Block encryption is generally a method of encrypting text by applying a cryptographic key and algorithm to a block of data as a group. Block encryption algorithms encrypt identical text, located in different portions of a body of text, differently; making deciphering encrypted text more difficult.

Inputs to block encryption algorithms are generally an encryption key and a cleartext block. The output of such an algorithm is a ciphertext block. In many of these methods, the ciphertext has an equal number of bits as the input cleartext block.

One such method is the Advanced Encryption Standard (AES), also known as the Rijndael algorithm. (“Advanced Encryption Standard (AES), Federal Information Processing Standards Publication 197 (FIPS 197), Nov. 2001. (Available at http://csrc.nist.gov/publications/fips/fips197/fips-197.pdf). The AES algorithm inputs a 128-bit cleartext block and a 128-bit key. The algorithm transforms the cleartext block using the key into a corresponding ciphertext through 10 almost identical ‘rounds’ of computation. Each round inputs 4 double words (1 dword=4 bytes) and outputs 4 dwords. The output of one round is saved to memory, such as a cache, and that output is subsequently read from memory to serve as input for the next round. The AES further provides for 128, 192, and 256-bit keys and cleartext blocks creating nine combinations of possible key length and cleartext block lengths.

An example of the AES, when using a 128-bit key, includes performing ten rounds of processing to a cleartext block. The first nine rounds each perform four operations on the cleartext block. These four operations are SubBytes transformation, ShiftRows transformation, MixColumns transformation, and AddRoundKey transformation. The tenth round only includes three of the operations of the first nine rounds, forgoing the MixColumns transformation. At the end, or between, each of the rounds, the algorithm moves the round output out of the processor registers to a memory, such as a cache. Subsequent rounds include loading the round output of the immediately previous round back into the processor registers.

In an efficient implementation oriented towards the architecture of 32-bit microprocessors, a round transformation consists of 16 identical operation ‘sequences’. Each sequence includes: byte extraction from one of the four double words, a table lookup based on the extracted byte, and an accumulation through XOR. In a superscalar architecture, such as the Pentium IV, the byte extraction and accumulation are register based operations—as such, in a very idealized microprocessor architecture, they can be efficiently pipelined to attempt a ‘sequence throughput’ of 1 sequence per CPU cycle—resulting in an optimal throughput of 128 bits in 10*16=160 cycles, OR 0.80 its per cycle. This idealized output assumes a microprocessor architecture with adequate number of general purpose registers (GPRs), multiple execution units supported with a retirement rate of at least 3 instructions per cycle and 1-cycle execution latency for each of the instructions involved in a ‘sequence’. Short of this idealized architecture and with at least 14 GPRs, it can be proven that the optimal throughput is 0.58 bits per CPU clock cycle. However, the optimal throughput has not been approached to date.

For example, an implementation that lags behind the optimized throughput is a C-code implementation of the AES algorithm, attributed to Brian Gladman. (Available at http://fp.gladman.plus.com/cryptography_technology/index.htm). The Gladman implementation is very efficient, but the maximum encryption throughput realized on a Pentium 4 processor is 0.38 bits per CPU clock cycle. The same implementation, when ran as is on an architecture with 16 general purpose registers, such as the Pentium IV with EM64T technology, is not any better. This is significantly less than the optimal throughput of 0.58 bits per CPU clock cycle.

### BRIEF DESCRIPTION OF THE DRAWINGS

FIG. 1 is a block diagram of an example embodiment of a method of the inventive subject matter.

FIG. 2 is a dataflow diagram of an example embodiment of the inventive subject matter.

FIG. 3 is a schematic diagram of a system according to an embodiment of the inventive subject matter.

FIG. 4 is a block diagram of an example embodiment of a method of the inventive subject matter.

FIG. 5 is a block diagram of an example embodiment of a method of the inventive subject matter.

FIG. 6 is a block diagram of an example embodiment of a method of the inventive subject matter.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more tan one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

Modern encryption algorithms are generally computationally intensive. The clock speed of today's processors has significantly reduced processing latency. However, there are still latencies involved in encryption. These latencies often come from slow memory operations such as load and store operations. The inventive subject matter includes methods and systems for reducing latency in encryption by reducing the number of memory operations. Some embodiments of the inventive subject matter including the Advanced Encryption Standard (AES) algorithm approach an idealized (0.58 bits per CPU clock cycle) throughput of the AES algorithm.

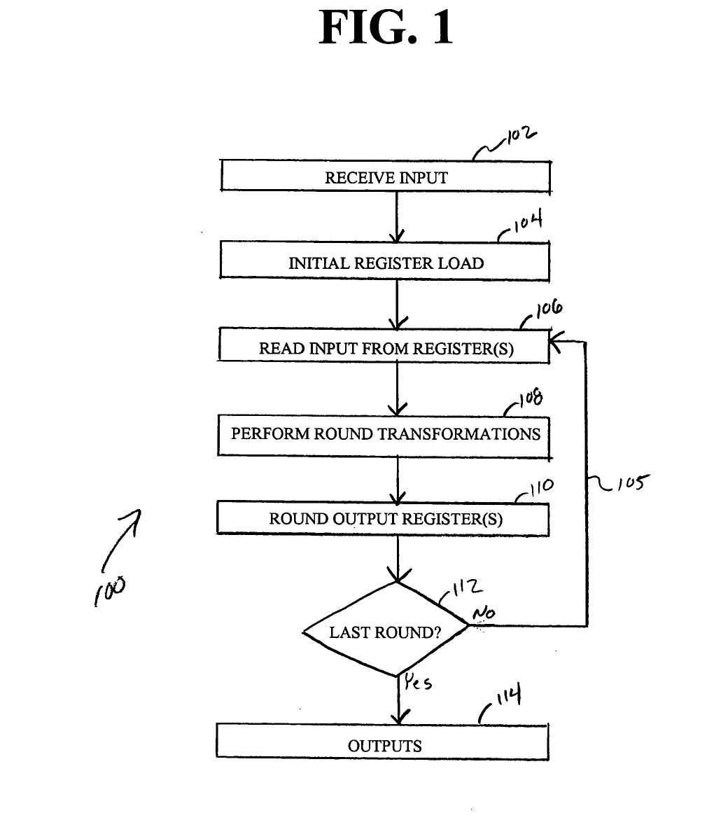

FIG. 1 is a block diagram of an example embodiment of a method 100 of the inventive subject matter. The example embodiment shown in FIG. 1 is a method 100 for iterative block encryption. The method 100 includes receiving input 102 and an initial register load 104 of one or more registers. The method 100 then iterates by reading input from the one or more registers 106, performing round transformations 108, moving round output to the registers 110, and determining if the current round is the last round 112. If it is not the last round, the method 100 iterates back to read input from the one or more registers 106 and proceeding through the method from that point forward. If it is determined that it is the last round 112, the method 100 outputs the result 114.

In some embodiments, the iterative block encryption algorithm of the method 100 is the Advanced Encryption Standard (AES). In various other embodiments the block encryption algorithm of the method 100 is the Data Encryption Standards (DES), triple DES, RC5, RC6, Blowfish, Skipjack, or virtually any other iterative block encryption algorithm.

The method 100 receives input 102. In some embodiments, the method 100 receives data to encrypt and an encryption key. In some such embodiments, the encryption key is 128 bits, but other embodiments include encryption keys of greater and lesser size. The data to encrypt is cleartext. In various embodiments, the cleartext includes alpha, numeric, and alphanumeric data. In some other embodiments, the method 100 receives data to decrypt and an encryption key.

The initial register load 104 of the method 100 includes loading one or more general-purpose registers of a processor with cleartext. In some embodiments, the initial register load 104 includes breaking the cleartext into blocks if the cleartext is of a size greater than a size the algorithm is able to process in one instance. In some embodiments, the initial register load 104 also includes loading all, or a portion of the encryption key into one or more registers. In other embodiments, the initial register load includes loading one or more memory addresses of some or the entire encryption key.

The iterative portion of the method 105 then begins. The iterative portion 105 first reads input from the one or more registers 106. In some embodiments, this includes reading one or more text blocks and a round encryption key. In some iterations of the iterative portion 105, the data read as input from the one or more registers 106 is an output of a previous round of the iterative portion 105 of the method. This eliminates a slow memory operation for reading the input from a memory by instead reading the input from a faster register of the processor.

Round transformations are then performed 108 on the input. The round transformations performed 108 vary between implementations of the method 100 based on the specific iterative block encryption algorithm chosen for the implementation. As an example of such transformations, the transformations of the AES algorithm are discussed below.

Once the round transformations have been performed 108, the method 100 then loads the round output back into the one or more registers 110. By loading the round outputs into the fast register space 110, another slow memory operation is eliminated. In some embodiments, the round output replaces the round input in the one or more registers. In other embodiments, the round output is loaded into a separate group of one or more registers.

Once the round transformations have been performed 108 and the round output loaded to the one or more registers 110, the method 100 determines if the current round is the last round 112. If it is the last round, the method 100 outputs 114 the encrypted ciphertext or decrypted cleartext and the method is complete. If the current round is not the last round, the method returns to the beginning of the iterative portion 105 reads input from the one or more registers 106. The method 100 continues in this iterative fashion until the last round has been performed and the encrypted ciphertext or decrypted cleartext has been output 114.

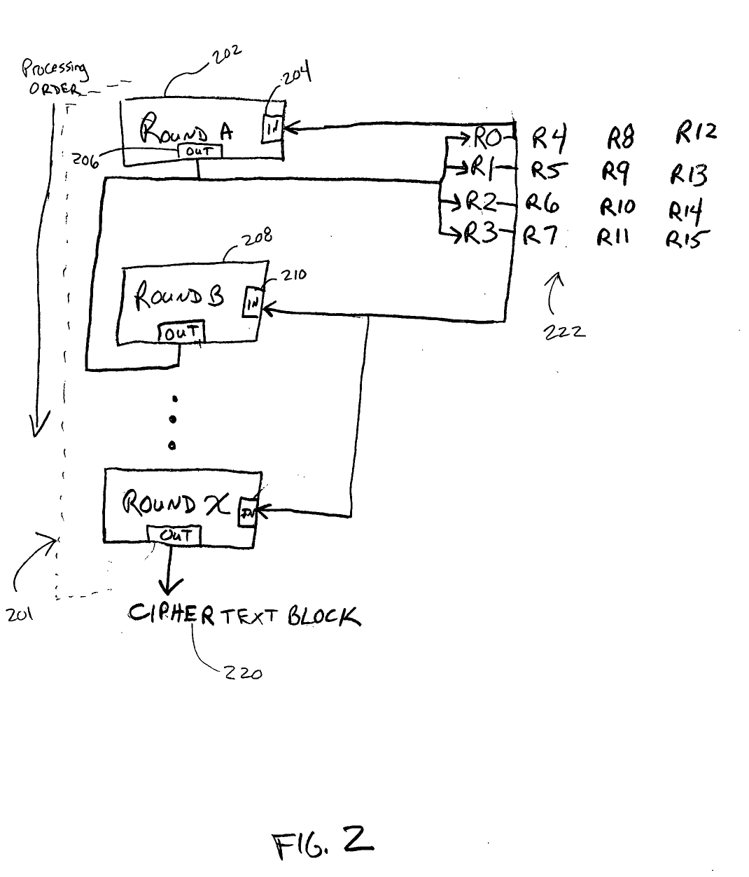

FIG. 2 is a dataflow diagram of an example embodiment of the inventive subject matter. This description of FIG. 2 describes encrypting data. However, the illustration is equally applicable to the operation of the inventive subject matter when decrypting.

The dataflow diagram of FIG. 2 includes X rounds 201, where X is the total number of rounds, and registers 222 of a processor. The rounds 201 are illustrative of rounds of an iterative block encryption algorithm. Sixteen registers 222 (R0-R15) are illustrated in the example diagram. This number of registers is merely an example. Some embodiments of the inventive subject matter include processors with as few as eight registers. The inventive subject matter is applicable to virtually a limitless number of registers.

The initial register 222 state of data to be encrypted is established by an initial register load 104 (as shown in FIG. 1). Round A 202 obtains the values from registers R0, R1, R2, and R3 as input 204. Round A 202 performs its round transformations and outputs 206 the round results back to registers R0, R1, R2, and R3. Round B 208 operates similarly to Round A, but the input 210 obtained from registers R0, R1, R2, and R3 is actually the output of Round A. This continues where the output of one round is the input for the next round and is available from the registers 222 until round results of the last round, Round X, are determined and output as the ciphertext block 220. By using the registers, such as registers R0, R1, R2, and R3, to hold the round output for quick access by the next round eliminates many memory operations. In the embodiment, eight memory operations per round are eliminated by performing four register reads and four register loads instead of memory read and load operations.

Various system embodiments of the inventive subject matter exist. Some embodiments include networking devices for interconnecting client computers to local area networks over the internet in a secure fashion. Some embodiments include devices for operating a virtual private network (VPN) such as client computers, routers, switches, hubs, and virtually any other networking device useful in computer or device networking. Some of these devices utilize the IPSec protocol for tunneling secure traffic over the IP protocol. Some embodiments also include storage server devices that either store user data on a local disc in an encrypted format, or transmits the data to a remote client using the IPSec protocol with the AES as the underlying encryption algorithm.

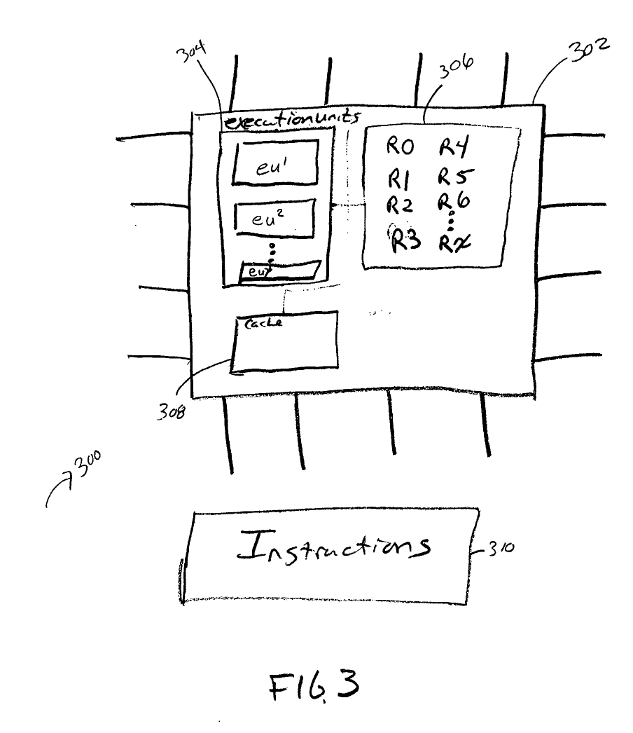

FIG. 3 is a schematic diagram of a portion of a system 300 according to an embodiment of the inventive subject matter. The system comprises a processor 302 and instructions 310 that are operable on the processor 302. The processor 302 comprises execution units 304, registers 306, and cache 308.

The processor 304 of the system 300 embodiment of FIG. 3 represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor 302 executes instructions. The processor 302 also includes a control unit that organizes data and program storage in memory (not shown), in cache 308, and the registers 306, and transfers data and other information in and out of the system 300. In some embodiments, the processor 304 is a superscalar processor. Examples of processor models include Intel® Pentium IV™, AMD® Opteron™, Motorola® PowerPC™, or virtually any other processor model with an appropriate number of registers 306 for practicing the inventive subject matter.

The execution units 304 include one or more execution units (eu¹, eu² . . . eu^{x}). In some embodiments, the processor includes a single execution unit. In other embodiments, the processors include multiple execution units, each execution unit tailored for a specific type of operation, such as a floating-point operation or a logical operation.

The registers 306, in some embodiments, comprise at least ten registers of at least 32-bits in width. In other embodiments, the registers 306 comprise fourteen or more general-purpose registers with varying numbers of bits. For example, some embodiments include 16-bit registers while other embodiments include 64-bit, 128-bit, or 256-bit registers.

The cache 308 of the system 300 includes a memory on the processor other than the registers 306. In some embodiments, the cache 308 comprises an L1 cache. In other embodiments, the cache 308 comprises one or a combination of L1, L2, and L3 caches.

The instructions 310 of the system 300 include instructions operable on and executable by the processor 302. In some embodiments, the instructions 310 are stored in Random Access Memory (RAM) or on a hard disk. In some embodiments, the instructions 310 are at least in part, stored in the processor 302 in cache 308 or in a Read Only Memory within the processor 302.

In some embodiments, the instructions 310, when executed by the processor, cause data to be encrypted or decrypted according to a multi-round, block encryption algorithm. The instructions 310 cause the processor to perform operations in multiple rounds, each round according to a block encryption algorithm to transform cleartext into ciphertext or ciphertext to cleartext. In the process of encrypting or decrypting, the instructions 310 cause the processor 302 to maintain the output from each round in a subset of the registers 306 to use as the input data in a next round. In some such embodiments, the instructions cause the processor 302 to use four registers R0, R1, R2, and R3 to maintain the round output to use and round input for the next round. In some further embodiments, the instructions further use one or more of the other registers 306 to track memory addresses of one or more encryption keys, such as four round keys in four registers. Yet further embodiments use one or more additional registers as scratch space. The scratch space is useful in some embodiments to track incremental variable, such as a round number, or intermediate values in obtaining a round output.

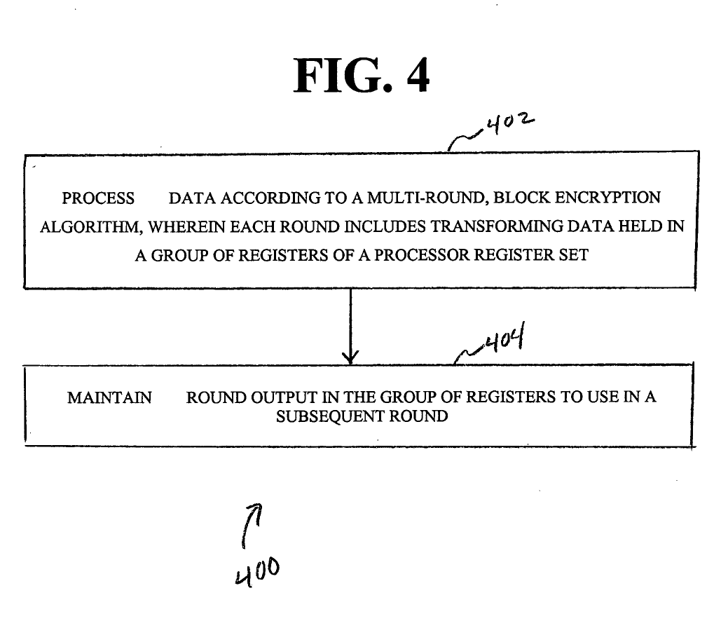

FIG. 4 is a block diagram of an example embodiment of a method 400 of the inventive subject matter. The method 400 includes processing data according to a multi-round, block encryption algorithm, wherein each round includes transforming data held in a group of registers of a processor register set 402. The method 400 further includes maintaining round output in the group of registers to use in a subsequent round 404. In some embodiments, the processing 402 data includes encrypting data. In other embodiments, the processing data 402 includes decrypting data.

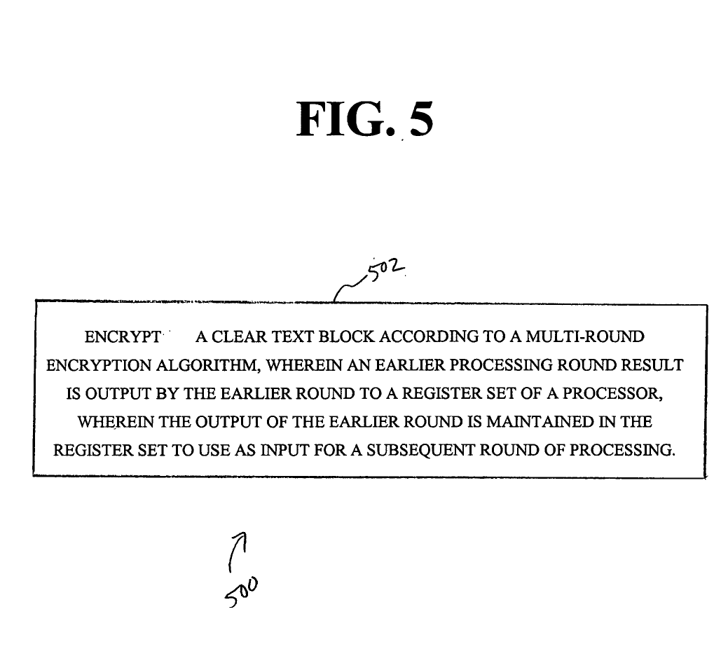

FIG. 5 is a block diagram of an example embodiment of a method 500 of the inventive subject matter. The method 500 includes encrypting a cleartext block according to a multi-round, encryption algorithm. The encrypting of the cleartext blocks includes outputting a round result to a register set of a processor and maintaining that output in the register set to use as input for a subsequent round of processing. In some such embodiments, the multi-round, encryption algorithm is the AES algorithm.

In some embodiments, the cleartext block is 128 bits in length. In some such embodiments, the cleartext block is initially loaded into a group of four 32-bit registers. The round outputs and the ciphertext block output of the method 500 are of symmetrical size as the input cleartext block.

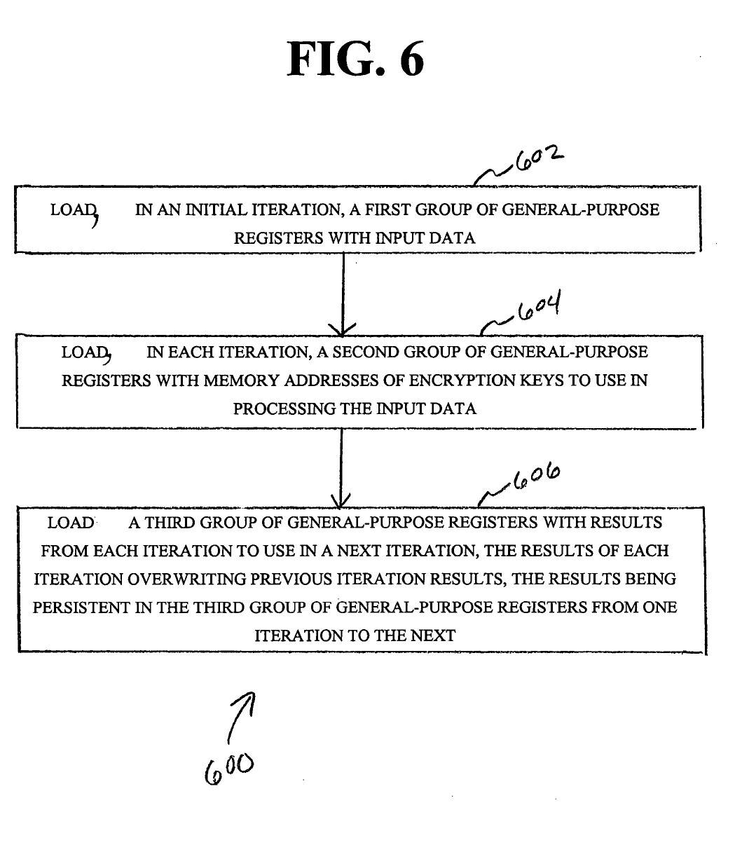

FIG. 6 is a block diagram of an example embodiment of a method 600 of the inventive subject matter. The method 600 utilizes general-purpose registers of a processor for holding round results to use as input the next round in performing iterative block encryption and decryption. The method 600 includes loading, in an initial iteration, a first group of general-purpose registers with input data 602. The method 600 further includes loading, in each iteration, a second group of general-purpose registers with memory addresses of encryption keys to use in processing the input data 604. The method 600 also includes loading a third group of general-purpose registers with results from each iteration to use in a next iteration, the results of each iteration overwriting previous iteration results, the results being persistent in the third group of four general-purpose registers from one iteration to the next 606. In some such embodiments, the first group of registers and the third group of registers are the same group of four registers. In some other embodiments, the method 600 requires ten or more registers, including at least two scratch registers for use in holding temporary variable values.

It should be noted that the individual activities shown in the method diagrams do not necessarily have to be performed in the order illustrated or in any particular order. Moreover, various activities described with respect to the methods identified herein may be executed in serial or parallel fashion. Some activities may be repeated indefinitely, and others may occur only once. Various embodiments may have more or fewer activities than those illustrated.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
processing data according to a multi-round, block encryption algorithm, wherein each round includes transforming data held in a group of registers of a processor register set; and
maintaining round output in the group of registers to use in a subsequent round.

2. The method of claim 1, wherein the group of registers comprises a group of at least ten registers.

3. The method of claim 1, wherein the multi-round, block encryption algorithm is the Advanced Encryption Standard algorithm.

4. The method of claim 1, wherein transforming data held in a group of registers includes transforming data held in 32-bit registers.

5. The method of claim 1 wherein the processing includes encrypting data.

6. The method of claim 4, wherein the processing includes decrypting data.

7. A method comprising:
encrypting a cleartext block according to a multi-round encryption algorithm, wherein an earlier processing round result is output by the earlier round to a register set of a processor, wherein the output of the earlier round is maintained in the register set to use as input for a subsequent round of processing.

8. The method of claim 7, wherein encrypting a cleartext block according to a multi-round encryption algorithm in performed in accordance with the AES.

9. The method of claim 7, wherein encrypting a cleartext block includes encrypting a 128-bit cleartext block.

10. The method of claim 9, wherein the output is maintained in a register set that includes ten or more 32-bit general-purpose registers.

11. The method of claim 7, wherein encrypting a cleartext block includes encrypting a 256-bit cleartext block.

12. The method of claim 7, wherein the cleartext block is a string.

13. A method of utilizing general-purpose registers of a processor for iterative block encryption, the method comprising:
loading, in an initial iteration, a first group of four general-purpose registers with input data;
loading, in each iteration, a second group of four general-purpose registers with memory addresses of encryption keys to use in processing the input data; and
loading a third group of four general-purpose registers with results from each iteration to use in a next iteration, the results of each iteration overwriting previous iteration results, the results being persistent in the third group of four general-purpose registers from one iteration to the next.

14. The method of claim 13, wherein the first group of four registers and the third group of four registers are the same group of four registers.

15. The method of claim 13, wherein each of the first, second, and third groups of registers each include four registers.

16. A computer system comprising:
a processor comprising eight or more general purpose registers;
a memory; and
a computer readable medium having instructions executable by the processor from memory to cause the system to:
receive a text block for encryption into a first group of general-purpose registers;
receive an encryption key into a second group of general-purpose registers; and
perform an iterative block encryption algorithm on the contents of the first group of registers, wherein each iteration of the block encryption algorithm is further to encrypt the received text block utilizing at least a portion of the encryption key, to replace the contents of the first group of general-purpose registers, and to use the contents of the first group of general-purpose registers in subsequent iterations.

17. The computer system of claim 16, wherein the general-purpose registers are 32-bit registers.

18. The computer system of claim 16, wherein the block encryption algorithm is an embodiment of the Advanced Encryption Standard algorithm.

19. The computer system of claim 16, wherein the processor is a superscalar processor.

20. The computer system of claim 19, wherein the superscalar processor is a Pentium® IV available from Intel Corporation.

21. The computer system of claim 16, wherein the text block and encryption key are 128 bits.

22. The computer system of claim 16, wherein the system is a personal computer.

23. The computer system of claim 16, wherein the system is a router.

24. The computer system of claim 16 further comprising:
wherein the instructions further comprise instructions to cause the system to:
receive into a third group of registers, a result from an iteration of the iterative block encryption algorithm; and
replace the contents of the first group of general-purpose registers by copying the result of the iteration of the iterative block encryption algorithm from the third group of registers.

25. The computer system of claim 24, wherein the instructions further comprise instructions to cause the system to:
utilize a group of two or more registers as scratch space during execution of the instructions.

26. A system comprising:
at least one processor to perform encryption according to a multi-round, block encryption algorithm, wherein each round includes transforming data held in a group of four registers of a processor register set; and
one or more modules to maintain round output in the group of four registers for use in a subsequent round.

27. The system of claim 26, wherein the block encryption algorithm is the Advanced Encryption Standard algorithm.

28. The system of claim 26, wherein the registers are 32-bit registers.

29. The system of claim 26 further comprising:
at least one module to receive a 128-bit data block to encrypt and a 128-bit encryption key.

30. An article comprising a machine accessible medium having associated instructions to encrypt data according to a multi-round, block encryption algorithm, wherein the instructions, when accessed, result in a machine:
performing operations in each round according to a block-encryption algorithm to transform input data into ciphertext; and
maintaining the ciphertext from each round in a group of registers to use the ciphertext as the input in a subsequent round.

31. The article of claim 30 wherein, in maintaining the ciphertext from each round in the group of registers, the ciphertext is maintained in a group of registers from a total of eight or more general-purpose registers.

32. The article of claim 31 wherein, in maintaining the ciphertext from each round in the group of registers, the registers are 32-bit registers.
